(19) United States
(12) Patent Application Publication
(10) Pub. No.: US 2004/0045107 A1
(43) Pub. Date: Mar. 11, 2004

(54) Water pressure driven tooth brush (hydratoothbrush) with dental jet

(76) Inventor: Zoltan Egeresi, Santa Cruz, CA (US)

Correspondence Address: ZOLTAN EGERESI, 5500 COAST Rd., SANTA CRUZ, CA, 95060, US

(21) Appl. No.: 10/238,364

(22) Filed: Sep. 10, 2002

(51) Int. Cl. A61C 17/28

(52) U.S. Cl. 15/29; 15/28; 601/162; 601/165

(57) ABSTRACT

This oral cleansing device assembly is an oral hygiene tool, which connects to the water faucet, uses normal water pressure in the system. All electric toothbrushes use a small motor, rechargeable or alkaline battery operated.

High frequency vibrators, or piezo electric drive to rotate or oscillate the tooth brush head.

This invention uses no electricity, no battery, brush driving power is derived from the water system.

This combination, dual mode invention has two modes of operation, tooth brushing and dental jet.

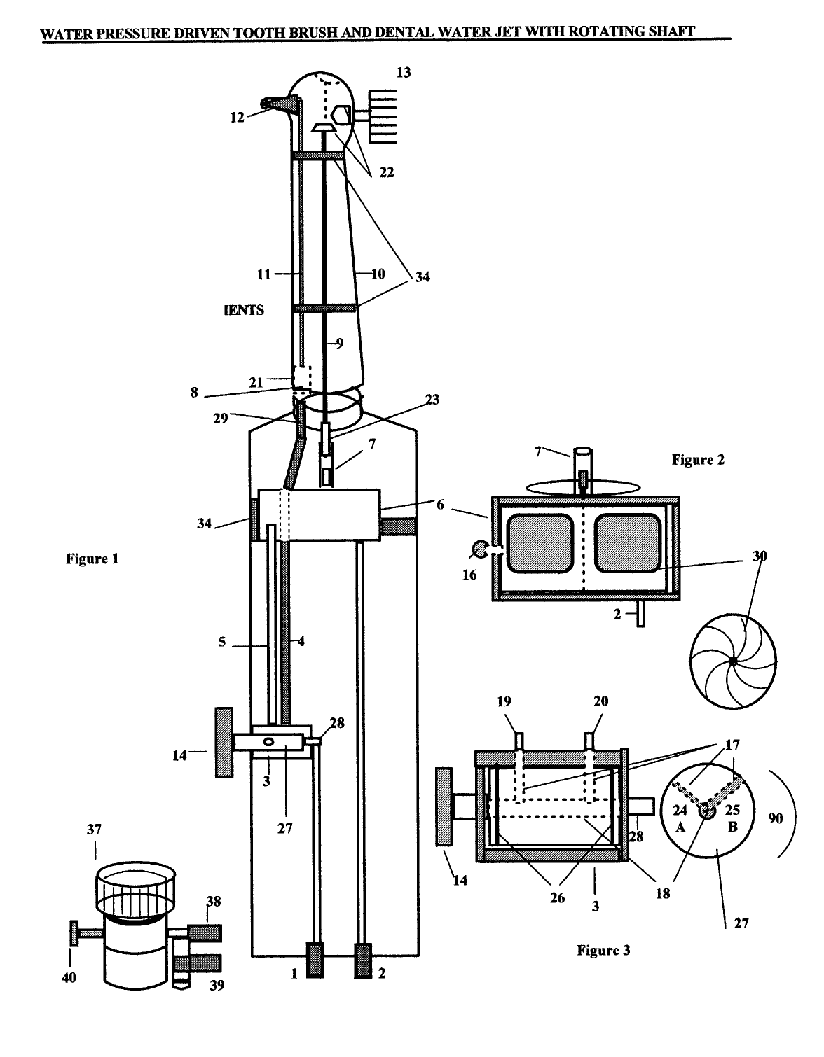

The oral cleansing device assembly consists of a diverter at the end of the faucet connecting to the HydraToothBrush with a vinyl or similar plastic tube to activate it. The water comes into the built in diverter with adjustable flow and direction control, water flows trough the impeller, it rotates a detachable shaft in the brush/water jet assembly. In FIG. 1 page 1 and in FIG. 11 on page 4 shaft transfers the rotation trough cone gears to the tooth brush. In FIG. 4 page 2 the brush driving power derives from the rotating disk with bumps on it. As the water pressure driven disk rotates the brush driving shaft “rides” on the bumps and the brush will oscillate within 90 degrees. The shaft at the end is spring loaded, to return the shaft for the next lifting cycle. On page 3 FIG. 12 the rotating disk oscillates the brush in the head assembly. The built in diverter in the HyraToothBrush in the HydraJet mode diverts the water to the nozzle to clean any derbies from the oral cavities, from under the bridge works what the brush could not reach.

### SUMMARY OF THE INVENTION

The Water Pressure Driven HydraToothbrush and Dental Jet is a dual function dental cleaning apparatus where the removable brush/jet assembly is one piece and the device is driven by water pressure alone.

The ornamental designed herein called HydraToothbrush is designed for new and economical way to automate the tooth brushing with a built in Dental jet as it described and shown in the drawing pages.

The water pressure is the only source of energy driving the impeller, no chargeable or replaceable batteries, no water cups to fill or clean just connect the vinyl hose to the faucet's diverter.

The impeller driven motor rotates or oscillates the drive shaft which in turn oscillates the brush head drive shaft and thereby the brush head and bristles.

The oral cleansing device assembly is attachable to a faucet, providing uninterrupted water supply, steady water pressure and unlimited water flow. It will improve on dental healthy removing all derbies from the mouth, plaque and scale resulting in fresher breath and improved general dental health.

### FIELD OF THE INVENTION

The present application relates to an oral irrigation fluid-dispensing device, water delivery system dental cleaning and tooth brushing. The present application further relates to such a device specifically equipped with an irrigating brush accessory for brushing and irrigating the external surfaces of the teeth and the gums, gingival sulcus.

### BACKGROUND OF THE INVENTION

Periodontal inflammation is one of the most common diseases of the adult population. Periodontal inflammation is induced by the dental plaque, a mixture of bacteria embedded in an adhesive matrix, present on the tooth surface particularly at the interdental spaces and near the gums.

The initial pathological reaction to the plaque, called gingivitis, is expressed by the soft gum tissue as redness, bleeding, swelling, bad breath and sour taste. Later, over a period of several years, the gum disease progresses and causes destruction of the tooth supporting bone, leaving a pathologic space between the tooth root and the gum. This space is the periodontal pocket. The plaque extends into the pockets, from which it cannot be removed by conventional oral hygiene methods, such as brushing and flossing. This plaque induces further damage, increasing the pocket size in depth and width, with eventual tooth loss. In addition to the gingivitis, plaque present in the interdental space also causes interproximal tooth decay. Irrigation can be defined simply as “the flushing of a specific site or area with a stream of fluid delivered by an irrigator”. In 1968, the first powered oral irrigation device, WaterPik.RT. (Teledyne WaterPik), was accepted by the American Dental Association for its ability to remove food particles and debris from interdental areas and below the gum line. This device was widely recommended by the dentistry.

All prior arts irrigators designed for home care by the patient consist of a power driven pump or flexible syringe bulb and a tip.

### BRIEF DESCRIPTION

This new invention is the Water Pressure Driven HydraToothbrush and Dental Jet.

The ornamental designed herein called HydraToothbrush is designed for new and economical way to automate the tooth brushing with a built in Dental jet as it described and shown in the drawing pages.

The HydraToothbrush connects to a faucet diverter as a source of water and energy has a special removable, interchangeable head assembly used for brushing the teeth and the Water jet section to flush out food derbies left behind by the brushing. Diverter has dual functions, selecting the water to the impeller or to the Dental Jet. In fully diverted position the water flow is the maximum, and in partial diverted position brush rotation becomes slower. In the DentalJet position water pressure also reduced in partial divertion. On page 1 the HydraToothbrush uses the water pressure driven impeller to rotate the shaft which connects to a cone gear to rotate the tooth brush. Rotating shaft driven Detachable Brush/Jet head.

On page 2 the rotating shaft is spring loaded, connects to the disk driver, which oscillates the brush.

On page 3 FIG. 8 shows water pressure activated coupling to the Dental Jet with and expandable bulb.

As the water is diverted to the detachable brush/jet assembly, the expandable bulb slides inside the small tube connecting to the jet's nozzle.

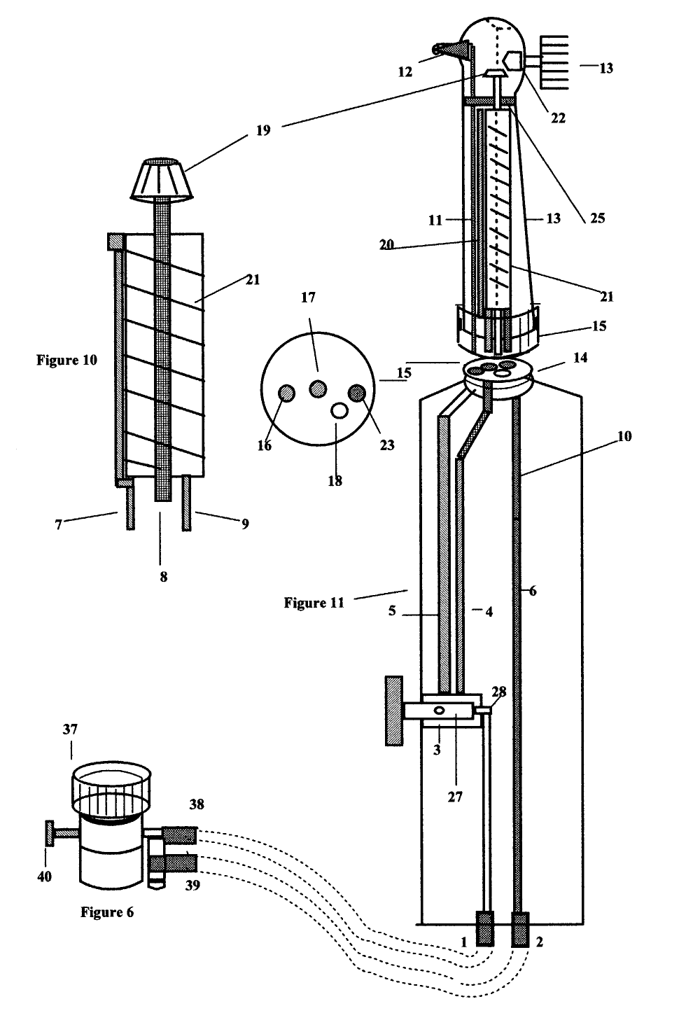

On page 4 FIG. 10 shows a Longitudinal impeller built into the Brush head/Dental jet assembly.

This is a dual Hydrabrush/Dental jet assembly connects to the handle with threaded coupling.

Water connections are sealed with O rings. The Hydrabrush/HydraJet assembly is detachable, interchangeable for the user.

My invention resides not in any one of these features per se, but rather in the particular combination of all of them herein disclosed and claimed and it is distinguished from the prior art in this particular combination of all of its structures for the functions specified.

### DETAILED DESCRIPTION OF DRAWINGS

This new invention is the Water Pressure Driven HydraToothbrush and Dental Jet.

The ornamental designed herein called HydraToothbrush is designed for new and economical way to automate the tooth brushing with a built in Dental jet as it described and shown in the drawing pages 14.

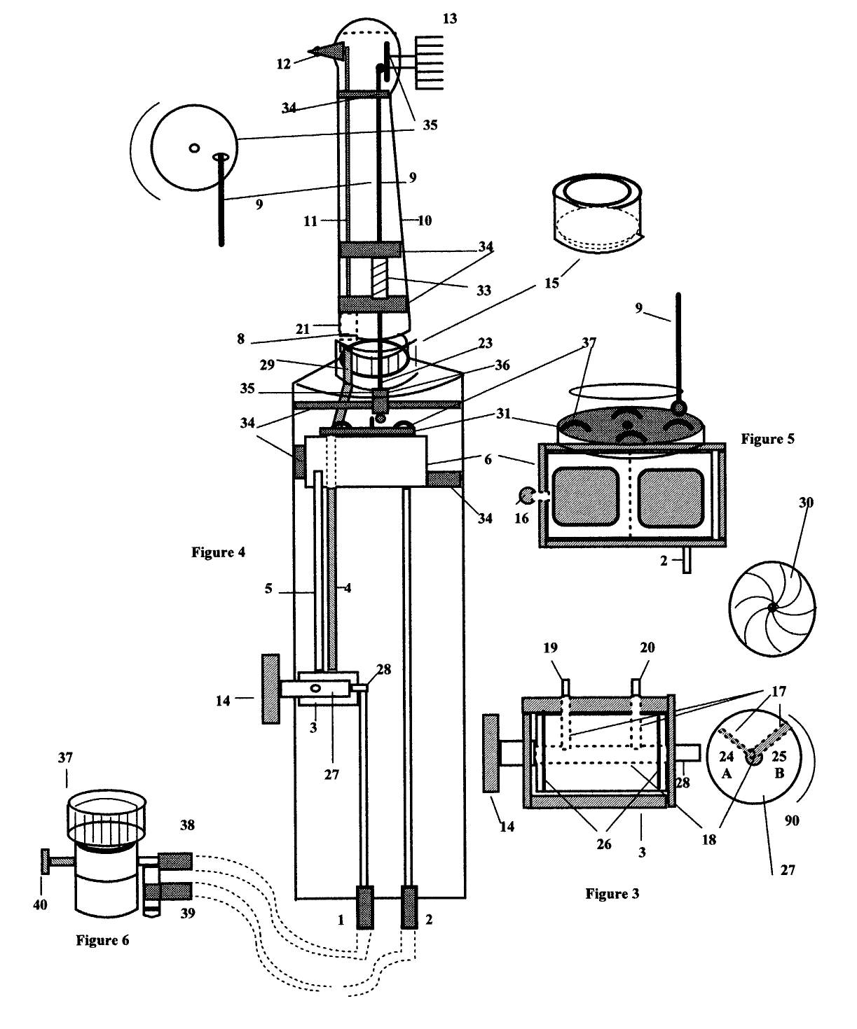

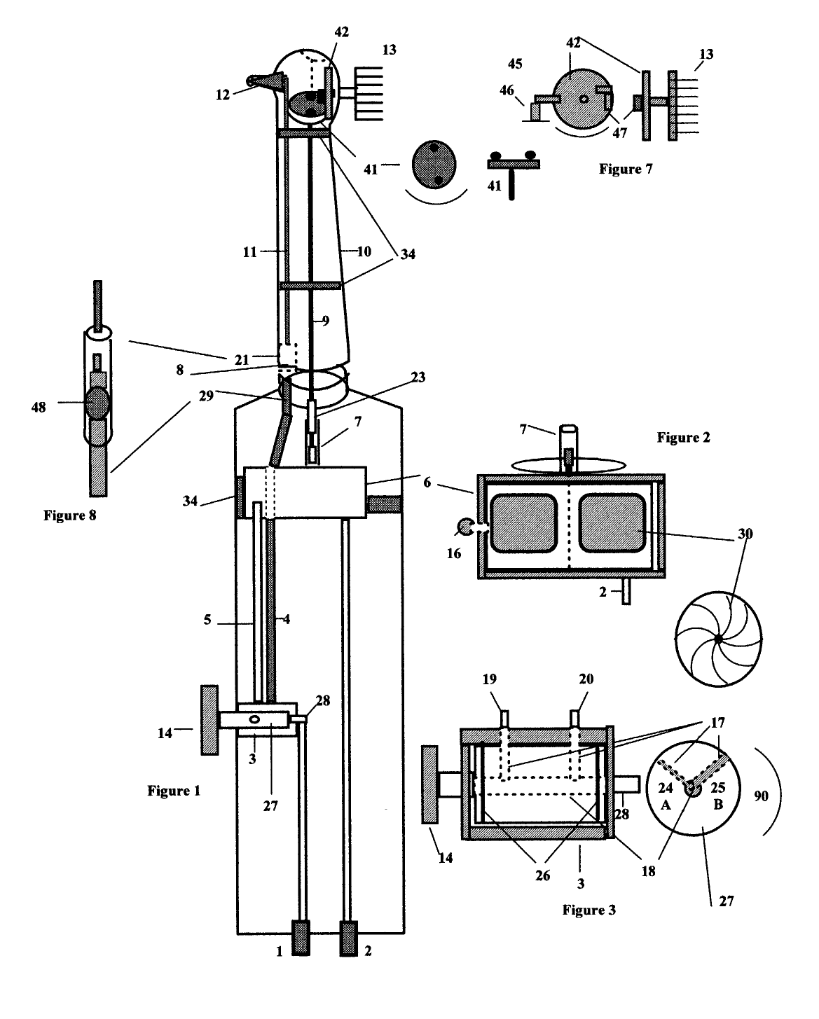

On Page 1 FIG. 1. The HydraToothbrush 's water intake (1) connects to a faucet diverter (37) at connection (38) to diverter's intake (28) Diverter knob (14) of diverter (3) has three positions, off, Brush Drive and Dental Jet as a source of water and energy to drive the impeller assembly (6) used for the brush driver. Diverter (3) in Brushing mode (A) (FIG. 3) channels the water from intake (28) through the center of diverter drum out to connection (19) tube (5) (FIG. 1) into the Water jet impeller (6) at connection (16). Impeller (30) is driven by the water pressure, and the water flows out at connection (2) to the faucets' discharge (39) connection. Flexible ¼ vinyl hose or similar food grade hose is used with minimum 75 PSI rating. The shaft (9) connects to the water engine (turbine) at coupling (7). The detachable brush/jet assembly (10) holds the shaft (9) with spacers/bearings (34). At the top of the shaft gears (22) drive the tooth brush (13) in a one directional rotating motion. Item (26) is O ring in the diverter.

In the DentalJet mode diverter (3) in B position channels the water through outlet (20) to tube (4) male coupler (29) with O ring (8) female receptacle (21), tube (11) to the Jet nozzle (12). Detachable brush/jet assembly has a snap on fitting to the handle.

On Page 2 driving the impeller (water turbine) engine (6) is the same as explained before, accept the power transfer. When the impeller (30) the shaft of the impeller is connected to the rotating disk (31) (FIG. 5 exploded view) with bumps (37) on it's surface. Shaft (9) rides on the rotating (37) bumps up and down where spring (33) returns the shaft (9) into the relaxed position. Spacers (34) hold and guide the shaft (9) and water jet tube (11). When shaft (9) moves up and down it is connected to the back plate of the tooth brush (13) and it will oscillate it. Detachable brush/jet assembly is connected to the handle with threaded shouldered nut 15. In DentalJet mode operation same as described before.

On page 3 of the drawing the oral cleansing HydraToothbtrush in Brushing mode water impeller (6) rotates the shaft (9) in the detachable brush/dental jet (10) assembly. At the end of shaft (9) rotating disk (41) with small bums on it, will pivot the back of the brush plate (42) in an oscillating mode. On the back side of rotating brush plate (42) cam (47) rides on the rotating disk (41) as a cam follower. Position restoring arm (45) is riding on a spring (46) to return the brush in the normal, rest position.

In the Dental jet mode diverter (3) channels the water up in tube (4) to the brush/jet assembly. Exploded view FIG. 8 shows the waterjet connection with an inflatable bulb (48). Diameter of the incoming water line is larger than the out flow 1/16″, creating a pressurized bulb to hold the water in line (11) and out to the water nozzle 12.

On Page 4 in FIG. 11 the water supply to the diverter (3) is same as described before. The major difference in this invention is the worm gear type impeller drive (21) exploded impeller view FIG. 10 which is located in the Brush/Dental jet detachable assembly. The top of the handle terminates with elevated O rings, water to Dental jet (16), water to worm gear impeller (17), (7), tube (20) water from impeller (21) flows out at (9) O ring (23) to tube (6), connector (2) flexible vinyl tube to faucet diverter (37) through out connection (39) into the sink.

Detachable brush/waterjet assembly is connected together with tightening nut (15) to threaded (14) top of handle. In the Brush mode diverter (3) channels water up to the impeller drive and rotates the driving gear (19) which rotates the brush gear (22) than brush (13) itself.

In Dental jet mode diverter (3) in handle is in waterjet mode, channels water up in tube (5), O ring (16), jet tube 11 to the nozzle (12).

### References in U.S. Patent Documents

U.S. Pat. No. 5,974,613 November 1999 Herzog, U.S. Pat. No. 4,698,869 October 1987 Mierau et al., U.S. Pat. No. 5,416,942 May 1995 Baldacci et al. U.S. Pat. No. 5,448,792 September 1995 Wiedermann, U.S. Pat. No. 5,697,117 December 1997 Craft, U.S. Pat. No. 5,421,726 6/Okada U.S. Pat. No. 5,165,131 November 1992 Staar, U.S. Pat. Nos. 4,302,186; 4,229,634; 4,337,040; 4,989,590 Waterpik

Foreign Patent Documents

39 37 850 November 199 Germany, 42 39 251 May 1994 Germany, 09300812 November 1993 Belgium

### FIELD OF INVENTION

The field of invention relates to oral hygiene tool, new and improved oral irrigation System.

### BACKGROUND OF THE INVENTION

This invention relates to teeth cleaning apparatus that can enhance oral cleaning and at the same time provides a new way for the process.

Field of search: 128/41, 433/80, 601/165, 601/165, 601/162, 163, 164

US Classification: 433/80, 601/162, 601/165

International Classification: A61G, 17/02, A61C17/02

### PRIOR ART

U.S. Pat. No. 5,974,613 Herzog Nov. 2, 1999 describes the brush section for an electric toothbrush. The invention is directed to a brush section for an electric toothbrush which includes a mounting tube in which a shaft rotationally mounted about a longitudinal axis and driveable in an oscillatory or rotary fashion is received. The brush section includes a bristle carrier which is pivotally mounted on an angled end of the shaft configured as crankshaft and which, n operation of the electric toothbrush, is set in a rotary motion about the transverse axis. The brush sections described in German Offen-legungsschrift DE 39 37 850 A1, this is an oscillatory rotational motion about the longitudinal axis of the drive shaft, with the angular range swept in rotation being +/−35 degrees, approximately.

U.S. Pat. No. 5,943,723 Hilfinger, et al. Aug. 31, 1999 Electric toothbrush. The invention is directed to an electric toothbrush in which a timing element is provided whose purpose it is to indicate to a user the end of at least one cleaning period when the electric toothbrush is activated. Still further, means coupled to the timing element are provided to enable the user to trigger the beginning of the cleaning period.

U.S. Pat. No. 5,165,131 Staar Nov. 24, 1992 Teeth cleaning apparatus. A teeth cleaning apparatus has a brush pivotally mounted in a brush holder. The brush has a teeth cleaning member such as bristles formed thereon. A vibrator exerts a vibratory force on the brush so that the teeth cleaning member moves back and forth in substantially its axial direction. The vibrator is driven by an electrical signal which preferably is of a frequency between 1,000 and 17,000 Hz and includes an audio frequency component of mixed frequency and amplitude representing music or other pleasant sounds which is transmitted to the auditory system of a person while brushing.

A motor powered toothbrush is described in detail in application Ser. No. 08/254,309 now U.S. Pat. No. 5,613,259, filed Jun. 6, 1994, for “High Frequency Electric Toothbrush”. Such a toothbrush includes a handle housing an electrically powered drive motor with a drive shaft extending from one end of the handle, and a removable brush head assembly in driving engagement with the drive shaft.

### SUMMARY OF THE INVENTION

The Water Pressure Driven HydraToothbrush and Dental Jet is a dual function dental cleaning apparatus where the removable brush/jet assembly is one piece and the device is driven by water pressure alone.

The ornamental designed herein called HydraToothbrush is designed for new and economical way to automate the tooth brushing with a built in Dental jet as it described and shown in the drawing pages.

The water pressure is the only source of energy driving the impeller, no chargeable or replaceable batteries, no water cups to fill or clean just connect the vinyl hose to the faucet's diverter. The impeller driven “turbine” motor rotates or oscillates the drive and the brush head itself.

I believe after a long patent search that my invention is unique, original, and have not seen it in any place published or marketed as stated in my claim. There are many types of tooth brushing systems on the market as listed in the Prior Art, but this HydraBrush/Dental jet provides a new way of dental maintenance.

This application is directed to the Patent Office of the United States.

I, the under signed inventor, Zoltan Egeresi have typed, drew, reviewed all aspect of this invention.

What is claimed is:

What is claimed as being a new invention is the Water Pressure Driven HydraToothbrush and Dental Jet:

1. Looking for the protection of the United States Patent Office for the said following claims.
The ornamental designed herein called HydraToothbrush is designed for new and economical way to automate the tooth brushing with a built in Dental jet as it described and shown in the drawing pages.
1. The HydraToothbrush has a special removable, interchangeable head assembly used for brushing the teeth and Water jet section to flush out food derbies left behind by the brushing.
2. Diverter has dual functions, selecting the water to the impeller or to the Dental Jet. In fully diverted position the water flow is the maximum, and in partial diverted position brush rotation becomes slower. In the DentalJet position pressure and water flow also reduced in partial divertion.
3. On page 1 the HydraToothbrush uses the water pressure driven impeller to rotate the shaft which connects to a cone gear to rotate the tooth brush. Rotating shaft driven Detachable Brush/Jet head.
2 On page 2 the rotating shaft is spring loaded, connects to the disk driver which oscillates the brush, the rotating motion is converted to an oscillating brush movement.
4. On page 3 FIG. 8 shows a water pressure activated coupling to the Dental Jet with and expandable bulb. As the water is diverted to the detachable brush/jet assembly the expandable bulb slides inside the small tube connecting to the jet's nozzle. The diameter of the incoming water line is larger than the diameter after the bulb. The water pressure will expand the bulb, keeping it tight.
6. On page 4 FIG. 10 shows a Longitudinal impeller built into the Brush head/Dental jet assembly. This is a dual Hydrabrush/Dental jet assembly connects to the handle with threaded coupling. Water connections are sealed with O rings. The Hydrabrush/HydraJet assembly is detachable, interchangeable for the user.
